(19) United States
(12) Patent Application Publication
(10) Pub. No.: US 2023/0257030 A1
(43) Pub. Date: Aug. 17, 2023

(54) EXTENDABLE CARGO BED WITH SIDE WALL STORAGE COMPARTMENT

(71) Applicant: Ford Global Technologies, LLC, Dearborn, MI (US)

(72) Inventors: Michael John Harmon, Northville, MI (US); Ryan Mathew Sandor, North Wales, PA (US); Matthew B. Rutman, Canton, MI (US); Dragan B. Stojkovic, Taylor, MI (US); Amol Borkar, Nagpur (IN); Christopher Bowser, Dearborn, MI (US)

(21) Appl. No.: 17/673,868

(22) Filed: Feb. 17, 2022

(51) Int. Cl. B62D 33/023

(52) U.S. Cl. CPC B62D 33/023

(57) ABSTRACT

A cargo bed system includes a bed wall assembly of a vehicle. The bed wall assembly has an outboard side and an inboard side. The inboard side is uninterrupted by a wheel well. A storage compartment is disposed between the outboard side and the inboard side. A bed floor assembly is movable back-and-forth between an extended position and a retracted position.

### TECHNICAL FIELD

This disclosure relates generally to an extendable cargo bed of a vehicle and, more particularly, to a cargo bed having side walls providing deep storage compartments.

### BACKGROUND

Some vehicles, such as pickup trucks, include a cargo bed. Users utilize cargo beds to carry various types of cargo. The cargo bed can be located behind a passenger compartment of the vehicle. A tailgate can enclose an aft end of the cargo bed.

### SUMMARY

In some aspects, the techniques described herein relate to a cargo bed system, including: a bed wall assembly of a vehicle, the bed wall assembly having an outboard side and an inboard side, the inboard side uninterrupted by a wheel well; a storage compartment between the outboard side and the inboard side; and a bed floor assembly that is movable back-and-forth between an extended position and a retracted position.

In some aspects, the techniques described herein relate to a cargo bed system, wherein the storage compartment opens to the outboard side.

In some aspects, the techniques described herein relate to a cargo bed system, wherein the storage compartment extends inboard past a wheel well of the bed wall assembly.

In some aspects, the techniques described herein relate to a cargo bed system, wherein the storage compartment extends from a first position that is in front of a rear wheel of the vehicle to a second position that is aft the rear wheel of the vehicle.

In some aspects, the techniques described herein relate to a cargo bed system, further including an electrical outlet within the storage compartment.

In some aspects, the techniques described herein relate to a cargo bed system, further including a lid pivotably coupled to the outboard side, the lid covering the storage compartment when the lid is in a closed position.

In some aspects, the techniques described herein relate to a cargo bed system, wherein a vertically bottom edge of the lid is pivotably coupled to the outboard side, the lid configured to provide a work surface when the lid is pivoted to an open position.

In some aspects, the techniques described herein relate to a cargo bed system, wherein the bed floor assembly includes a slidable floor and a fixed floor, the slidable floor disposed atop the fixed floor and slidable relative to the fixed floor.

In some aspects, the techniques described herein relate to a cargo bed system, wherein the inboard side and the fixed floor are directly joined to each other.

In some aspects, the techniques described herein relate to a cargo bed system, wherein the bed wall assembly is a driver side bed wall assembly, and further including a passenger side bed wall assembly having an inboard side directly joined to the fixed floor.

In some aspects, the techniques described herein relate to a cargo bed system, further including a divider gate having a fixed length, the divider gate configured to engage the inboard side of the driver side bed wall assembly and the inboard side of the passenger side bed wall assembly at a plurality of positions, the plurality of positions including a position in front of a pair of wheels, a position between the pair of wheels, and a position aft of the pair of wheels.

In some aspects, the techniques described herein relate to a cargo bed system, wherein a distance between the inboard side of the driver side bed wall assembly and the inboard side of the passenger side bed wall assembly is the same along an entire longitudinal length of the driver side bed wall assembly.

In some aspects, the techniques described herein relate to a cargo bed system, wherein the inboard side is inboard the wheel well of the vehicle.

In some aspects, the techniques described herein relate to a cargo bed system, wherein the inboard side includes a planar surface extending horizontally from a tailgate to a front wall of the vehicle, and extending vertically from the bed floor assembly to a top edge of the bed wall assembly.

In some aspects, the techniques described herein relate to a cargo bed system, further including a tailgate assembly that provides a pair of opposing side walls for an extended portion when the bed floor assembly is in the extended position.

In some aspects, the techniques described herein relate to a cargo bed usage method, including: storing items within a storage compartment between an inboard side and an outboard side of a bed wall assembly of a cargo bed of a vehicle, the storage compartment extending inboard past a wheel well of the vehicle; and extending a bed floor assembly of the cargo bed to provide an extended portion that is aft of a rear bumper of the vehicle.

In some aspects, the techniques described herein relate to a cargo bed usage method, further including utilizing a lid of the storage compartment as a work surface.

In some aspects, the techniques described herein relate to a cargo bed usage method, further including wherein the inboard side of the bed wall assembly is uninterrupted by a wheel well.

In some aspects, the techniques described herein relate to a cargo bed usage method, further including providing sides of the extended portion using a tailgate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a vehicle having a cargo bed with a storage compartment in a side wall.

FIG. 2 illustrates an overhead and rear perspective view of the vehicle of FIG. 1.

FIG. 3 illustrates the vehicle of FIG. 1 with a floor of the cargo bed in an extended position.

FIG. 4 illustrates a section view at line 4-4 in FIG. 1.

### DETAILED DESCRIPTION

This disclosure details a cargo bed for a vehicle. The cargo bed is extendable. At least one bed wall assembly of the cargo bed includes storage compartment.

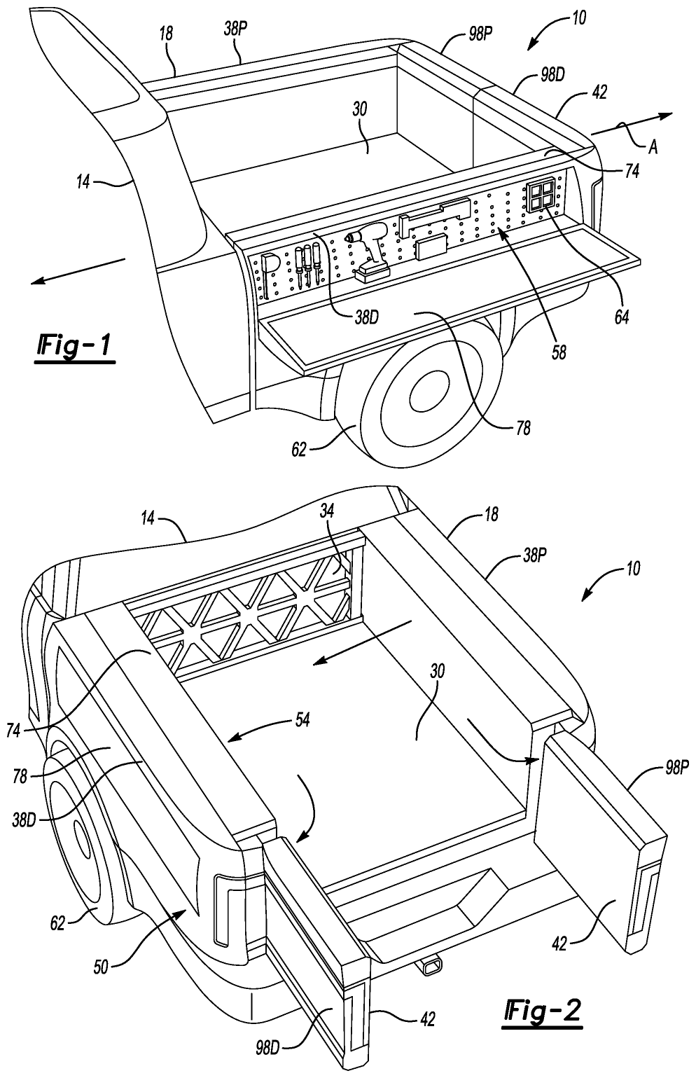

With reference to FIGS. 1-3, a vehicle 10 includes a passenger compartment 14 and a cargo bed 18 that is aft the passenger compartment 14 along a longitudinal axis A of the vehicle 10.

In the exemplary embodiment, the vehicle 10 is a pickup truck. The vehicle 10 could be another type of vehicle in another example, such as a car, van, sport utility vehicle, etc. The vehicle 10 has a unibody architecture. In another embodiment, the vehicle 10 could have a body-on-frame architecture.

The example vehicle 10 is an electrified vehicle. In particular, the vehicle 10 is a battery electric vehicle. In another example, the vehicle 10 could be another type of electrified vehicle, such as a plug-in hybrid electric vehicle (PHEV), or a conventional vehicle.

The example vehicle 10 includes an electrified powertrain capable of applying a torque from an electric machine (e.g., an electric motor) to drive a pair of wheels 22. The vehicle 10 can include a traction battery pack, which powers the electric machine and, potentially, other electrical loads of the vehicle 10. The powertrain of the vehicle 10 may electrically propel the wheels 22 either with or without the assistance of an internal combustion engine.

Generally, the cargo bed 18 is provided by a bed floor assembly 30, a front wall 34, a first bed wall assembly 38D, a second bed wall assembly 38P, and a tailgate assembly 42. The first bed wall assembly 38D has an outboard side 50, an inboard side 54, and a storage compartment 58 disposed between the outboard side 50 and the inboard side 54. The second bed wall assembly 38P is similarly constructed.

In the exemplary embodiment, the storage compartment 58 opens to an outboard side of the first bed wall assembly 38D. The storage compartment 58 extends along a longitudinal axis of the vehicle 10 from a position in front of a rear wheel 62 of the vehicle 10 to a position aft the rear wheel 62 of the vehicle 10. A user can store tools, accessories, cargo, etc. within the storage compartment 58. In this example, an electrical outlet 64 is exposed and accessible within the storage compartment 58. Items can be powered through the electrical outlet 64.

The rear wheel 62 on the driver side is received within a wheel well 66. As shown in FIG. 4, the inboard side 54 is spaced inboard from a wheel well 62 of the vehicle 10. A back wall of the storage compartment 58 is provided by the inboard side 54 of the first bed wall assembly 38D. The storage compartment 58 extends inboard past the wheel well 66. This provides a storage compartment 58 that is deeper than if the inboard side 54 were spaced further outboard.

The inboard side 54 is inboard the wheel well 62. The inboard side 54 is inboard enough that the inboard side 54 is uninterrupted by any wheel well projection or hump. The inboard side 54 includes a planar surface 70 defining a driver side outboard boundary of the cargo bed 18. The planar surface 70 extends horizontally from the front wall 34 to the tailgate assembly 42, and vertically from the bed floor assembly 30 to a vertically upper edge 74 of the first bed wall assembly 38D. Vertical, for purposes of this disclosure is with reference to ground and a general orientation of the vehicle 10 during operation.

A lid 78 is pivotably coupled to the outboard side 50. The lid 78 can move back-and-forth between an open position and a closed position. The lid 78 covers the storage compartment 58 when the lid 78 is in the closed position. In the exemplary embodiment, a vertically bottom edge of the lid 78 is pivotably coupled to the outboard side 50. The lid 78 can be moved to an open position where the lid 78 is oriented horizontally and can provide a worksurface for a user as shown in FIGS. 2 and 4.

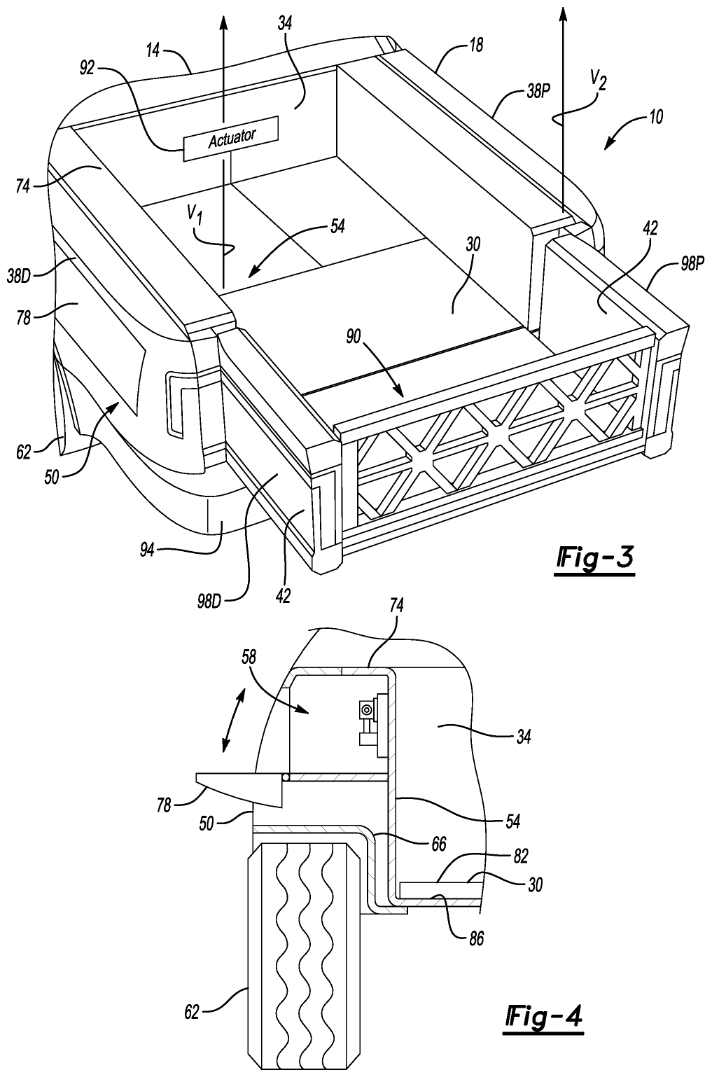

The example bed floor assembly 30 includes a slidable floor 82 and a fixed floor 86. The slidable floor 82 is disposed atop the fixed floor 86 and is slidable relative to the fixed floor 86. The bed floor assembly 30 is movable back-and-forth between the retracted position of FIGS. 1 and 2, and the extended position of FIG. 3. When the bed floor assembly 30 is in the extended position, an extended portion 90 of the slidable floor 82 extends aft a rear bumper 94 of the vehicle 10. The bed floor assembly 30 can be transitioned to the extended floor position to help a user transport more cargo within the cargo bed 18.

In this example, an actuator 92, such as a linear screw actuator, can be used to slide the slidable floor 82. Alternatively, a user could manually slide the slidable floor. The fixed floor 86 is directly joined to the inboard sides 54 of the bed wall assemblies 34D, 34P.

The example tailgate assembly 42 includes a split tailgate having a first door 98D that can pivot about a vertical axis V₁ and a second door 98P that can pivot about a vertical axis V₂. The first door 98D is on a driver side of the vehicle 10, and the second door 98P is on the passenger side of the vehicle 10. The first door 98D and the second door 98P are similarly sized in this example. The first door 98D and the second door 98P each account for about fifty-percent of the tailgate assembly 42. The first door 98D is configured to pivot about the axis V₁ back-and-forth between a closed position and a fully open position. The second door 98P is configured to pivot about a second vertically extending axis V₂ back-and-forth between a closed position and a fully open position.

FIG. 3 shows the first door 98D and the second door 98P each in a partially open position. In this position, the first door 98D and the second door 98P can provide opposing sidewalls for the extended portion 90 of the slidable floor 82.

The first door 98D and the second door 98P can be opened further to a fully open position. A user can then use the bed floor assembly 30 as a worksurface that can be accessed from three sides.

The inboard sides 54 of the first bed wall assembly 38D and the second bed wall assembly 38P are both planar and are oriented perpendicularly to each other. A distance between the inboard sides 54 is the same along an entire longitudinal length of the cargo bed 18. Thus, a cross-vehicle width of the cargo bed 18 is the same, (i.e., nominally the same) from a front of the cargo bed 18 to a rear of the cargo bed 18, and from a vertical bottom of the cargo bed 18 to a vertical top.

A divider gate 100 can be used in connection with the cargo bed 18. The divider gate 100 can engage the inboard sides 54 of the first bed wall assembly 38D and the second bed wall assembly 38P to partition the cargo bed 18. When not needed, the divider gate 100 can be stored against the front wall 34 of the vehicle 10. The divider gate 100 has a fixed length.

Since the cargo bed 18 has a consistent width along the length of the cargo bed 18, the divider gate 100 can be used at a plurality of positions along the cargo bed 18. The positions can include a position in front of the wheels 22, a position between the wheels 22, and a position aft of the wheels 22. At least because the inboard sides 54 include no wheel well projections, the divider gate 100 can be used at these different positions without adjusting a length of the divider gate 100.

The first bed wall assembly 38D and the second bed wall assembly 38P are each configured to transition back-and-forth between a standard wall position as shown in FIG. 1 and an extended wall position as shown in FIG. 2. The first bed wall assembly 38D and the second bed wall assembly 38P are parts of a cargo bed system that enables the cargo bed 18 to be transitioned back-and-forth between the standard bed position of FIG. 1 and the extended bed position of FIG. 2.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A cargo bed system, comprising:
a bed wall assembly of a vehicle, the bed wall assembly having an outboard side and an inboard side, the inboard side uninterrupted by a wheel well;
a storage compartment between the outboard side and the inboard side; and
a bed floor assembly that is movable back-and-forth between an extended position and a retracted position.

2. The cargo bed system of claim 1, wherein the storage compartment opens to the outboard side.

3. The cargo bed system of claim 1, wherein the storage compartment extends inboard past a wheel well of the bed wall assembly.

4. The cargo bed system of claim 1, wherein the storage compartment extends from a first position that is in front of a rear wheel of the vehicle to a second position that is aft the rear wheel of the vehicle.

5. The cargo bed system of claim 1, further comprising an electrical outlet within the storage compartment.

6. The cargo bed system of claim 1, further comprising a lid pivotably coupled to the outboard side, the lid covering the storage compartment when the lid is in a closed position.

7. The cargo bed system of claim 6, wherein a vertically bottom edge of the lid is pivotably coupled to the outboard side, the lid configured to provide a work surface when the lid is pivoted to an open position.

8. The cargo bed system of claim 1, wherein the bed floor assembly includes a slidable floor and a fixed floor, the slidable floor disposed atop the fixed floor and slidable relative to the fixed floor.

9. The cargo bed system of claim 8, wherein the inboard side and the fixed floor are directly joined to each other.

10. The cargo bed system of claim 9, wherein the bed wall assembly is a driver side bed wall assembly, and further comprising a passenger side bed wall assembly having an inboard side directly joined to the fixed floor.

11. The cargo bed system of claim 10, further comprising a divider gate having a fixed length, the divider gate configured to engage the inboard side of the driver side bed wall assembly and the inboard side of the passenger side bed wall assembly at a plurality of positions, the plurality of positions including a position in front of a pair of wheels, a position between the pair of wheels, and a position aft of the pair of wheels.

12. The cargo bed system of claim 10, wherein a distance between the inboard side of the driver side bed wall assembly and the inboard side of the passenger side bed wall assembly is the same along an entire longitudinal length of the driver side bed wall assembly.

13. The cargo bed system of claim 1, wherein the inboard side is inboard the wheel well of the vehicle.

14. The cargo bed system of claim 1, wherein the inboard side includes a planar surface extending horizontally from a tailgate to a front wall of the vehicle, and extending vertically from the bed floor assembly to a top edge of the bed wall assembly.

15. The cargo bed system of claim 1, further comprising a tailgate assembly that provides a pair of opposing side walls for an extended portion when the bed floor assembly is in the extended position.

16. A cargo bed usage method, comprising:
storing items within a storage compartment between an inboard side and an outboard side of a bed wall assembly of a cargo bed of a vehicle, the storage compartment extending inboard past a wheel well of the vehicle; and
extending a bed floor assembly of the cargo bed to provide an extended portion that is aft of a rear bumper of the vehicle.

17. The cargo bed usage method of claim 16, further comprising utilizing a lid of the storage compartment as a work surface.

18. The cargo bed usage method of claim 16, further comprising wherein the inboard side of the bed wall assembly is uninterrupted by a wheel well.

19. The cargo bed usage method of claim 16, further comprising providing sides of the extended portion using a tailgate.
